(19) United States
(12) Patent Application Publication
(10) Pub. No.: US 2003/0003909 A1
(43) Pub. Date: Jan. 2, 2003

(54) System and method for identifying service provider initiated location-dependent services in a mobile communication system

(75) Inventors: Seppo Keronen, Eastwood (AU); Ari-Pekka Varonen, Jyvaskyla (FI); Seija Salmela, Masala (FI); Petri Vesikivi, Espoo (FI); Timo Teimonen, Espoo (FI)

Correspondence Address: COHEN, PONTANI, LIEBERMAN & PAVANE, 551 Fifth Avenue, Suite 1210, New York, NY, 10176, US

(73) Assignee: Nokia Corporation

(21) Appl. No.: 09/896,964

(22) Filed: Jun. 29, 2001

(51) Int. Cl. H04Q 7/20

(52) U.S. Cl. 455/434; 455/551

(57) ABSTRACT

A method and system for providing location-specific service provider information to a mobile station. The location of a base station as well as the identities of service providers located within the base station operating region is provided to a mobile station in contact with the base station via the base station broadcast channel. A service provider is selected from the mobile station and a request is transmitted seeking information concerning the selected service provider. The request may contain the base station location so that location-specific service provider information will be provided to the mobile station in response to request.

### BACKGROUND OF THE INVENTION

1. Field of the Invention

The present invention relates to a mobile communication system arranged to broadcast general information on a broadcast channel to a mobile station for use in the solicitation of location-dependent services.

2. Description of the Related Art

Various service announcements can be transmitted to mobile stations on the basis of a service request of a subscriber in mobile communication systems. Generally, these services are most often arranged to be provided from outside the actual mobile communication system. By placing a call to a required service number, a mobile subscriber is able to order a selected service announcement to be delivered to the display of the mobile station, for example. These individual services may include weather forecast, traffic announcements, local news and other local services, such as taxi information, automobile service station announcements, mass transportation announcements and various other commercial service announcements where the mobile subscriber seeks the desired announcement on the basis of the subscriber's current geographic location. The mobile subscriber generally desires to have the service announcement related to the subscriber's current location which varies due to the mobile nature of the mobile subscriber.

In the European digital GSM mobile communication system, in addition to speech and data connections established on normal data traffic channels, it is possible to send short digital data messages which are referred to as short messages, in the control or signaling channels of the system. The GSM mobile network is connected to a separate short message service center SMSC which establishes a connection between a specific short message network and the GSM network. The short message service center SMSC is located outside of the mobile network and transmits short messages to mobile subscribers and from a mobile subscriber (subscriber A) to another mobile subscriber (subscriber B) or to any unit capable of receiving short messages outside of the mobile network. The subscriber inputs a short message to be sent by the keyboard of the mobile station or by a computer connected to the mobile station. The mobile station sends the short message on the control or signaling channel to the base station from which the short message is further transferred via the mobile switching center to the short message service center SMSC. The service center SMSC forwards the short message to the short message network. The short message service center SMSC transmits mobile-terminating short messages on the control or signaling channel.

For some services such as in the short message services pertaining to traffic reports, the service announcement is only useful if it is focussed accurately on the specific geographic region of the subscriber at the time the subscriber is requesting or obtaining the traffic-related message.

FIG. 1 shows a simplified block diagram of the pan-European GSM mobile communication system. The mobile station MS is connected via the radio path to one of the base transceiver stations BTS, such as the base station BTS1 in FIG. 1. The base station system BSS comprises a base station controller BSC and base stations BTS controlled by the BSC. Usually several base station controllers BSC are controlled by a mobile services switching center MSC. The mobile services stations switching center MSC is connected to other mobile services switching centers. A gateway mobile services switching center (GMSC) connects the GSM to other networks, such as the public switched telephone network PSTN, a public land mobile network PLMN, an integrated services data network ISDN or a service center SC, such as the short message service center SMSC. The operation and maintenance center OMC monitors the operation of the whole system. The subscriber data of the mobile station MS is stored permanently into a home location register HLR and temporarily into a visitor location register VLR in the area of which the mobile station MS is located at the time. The location information of the mobile station MS is stored into the visitor location register VLR at the accuracy of the location area LA. The geographical area monitored by the visitor location is divided into one or more location areas LA. One or more base stations BTS can operate in each location area.

The base station BTS continuously broadcast information on a broadcast channel about themselves and their environment, such as a base station identity code BSIC, adjacent cell information and a location area identifier LAI broadcast on a paging channel. The cell broadcast center situated at the base station controller BSC, for example, manages the messages of the cell broadcast channels of the base station BTS. The cell broadcast center transmits via the base station BSC, the broadcast messages assigned for each individual base station BTS on the basis of initial information supplied by the operator. The broadcast on paging channels and cell broadcast channels, for example, has no address nor is encrypted but is intended to be received by all mobile stations MS within the geographical area covered by the transmission of the base station. For a more detailed description of cell broadcast, reference is made to GSM recommendation GSM 03.41 “European digital cellular telecommunication system (Phase 2); Technical realization of Short Message Service Cell Broadcast( SMSCB)”.

In a system disclosed in PCT Patent Document WO 98/19479, a short message identifying a geographic location of a BTS currently serving a MS is transmitted to the MS for storage in a designated memory. When a user desires location-dependent services pertaining to or located proximate the presently stored geographic location, the user sends an SMS request to a service provider server and attaches or inputs the location information to the request. The requested information is then transmitted to the MS. Such a system requires user input of information which makes such a system inconvenient to use.

In such a system, the location information dynamically stored in the MS memory is treated as a read-only file and this data is not automatically forwarded with a service request. Thus, a MS user must retrieve the stored location information and enter it into a SMS service request or attach the location information file to the SMS service request. A further drawback is that the user must dynamically submit a request for local services information, as opposed to receiving such information automatically as the user enters the geographic coverage area of the BTS.

### SUMMARY OF THE INVENTION

To overcome limitations in the prior art described above, and to overcome other limitations that will become apparent upon reading and understanding the present specification, the present invention discloses a system, apparatus and method for communicating location-based services to a wireless terminal operating within a wireless network. The wireless device is not limited to any preset navigation structure, and provides the ability to remotely access services. The inventive method is directed to providing service information to a mobile station in communication with a base transceiver station. A message is broadcast over the cell broadcast channel of the base transceiver station which includes location information identifying a geographic location of the base transceiver station and information identifying service providers located within a coverage area of the base transceiver station. The message is then received at the mobile station and at least the location information of the base transceiver station is stored into a memory of the mobile station. At least the identifying service provider information is conveyed to the mobile station for access by a user of the mobile station. The user then selects at least one service provider from the identifying service provider information. The selected service provider is associated with the location information stored in the memory of the mobile station and a service information request is sent to a dedicated server. The request may contain service provider location association depending on a user preference. In response to the request, service information is provided to the mobile station.

The present invention is also directed to a system for providing service information to a mobile station in communication with a base transceiver station. The system includes means for broadcasting over the cell broadcast channel of the base transceiver station a message including location information identifying a geographic location of the base transceiver station and information identifying service providers located within a coverage area of the base transceiver station. A mobile station is provided for receiving the broadcast message. The mobile station includes a memory for storing at least the location information identifying the geographic location of the base transceiver station, means for conveying to a user of the mobile station at least the identifying service provider information, and means for selecting from the conveying means at least one service provider from the identifying service provider information. A means for associating the selected service provider with the location information stored in memory is also provided, along with means for sending, from the mobile station to a dedicated server, a request for service information of the selected service provider. The request may or may not contain service provider location association depending on a user preference. The requested service information is then provided to the mobile station, based on the user preference, via a providing means.

In another embodiment, the service information is provided from a cell broadcast center to the mobile station as part of a screen saver function where, when the mobile station is inactive, for example, the mobile station display will visually depict the requested services information.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 depicts a block diagram of the prior art pan-European GSM mobile communication system;

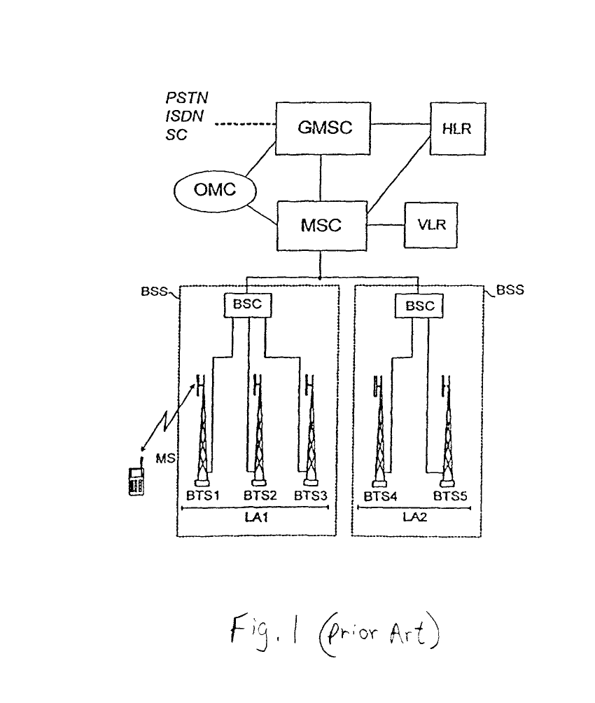

FIG. 2 depicts a block diagram of one embodiment of the invention;

FIG. 3 depicts a terminal display and an illustrative broadcast message used in the system of FIG. 1;

FIG. 4 depicts a flow diagram of one embodiment of the inventive method;

FIG. 5 depicts the screen saver feature of one embodiment of the invention; and

FIG. 6 is an illustration of a terminal device for use with the invention.

### DETAILED DESCRIPTION OF THE PRESENTLY PREFERRED EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention. The present invention can be applied in connection with any mobile communication system and, as an example, the invention is explained below in more detail in connection with the pan-European GSM mobile communication system (although it can be, likewise, used with other communication systems such as the GSM 1900 systems presently in use in the U.S.). In this application, the term “plain language location information” refers to universally intelligible location information which does not require a separate interpretation key or decoding table. The use of plain language location information is not intended to be restricted within the mobile communication system but may be universally utilized by any external system or device.

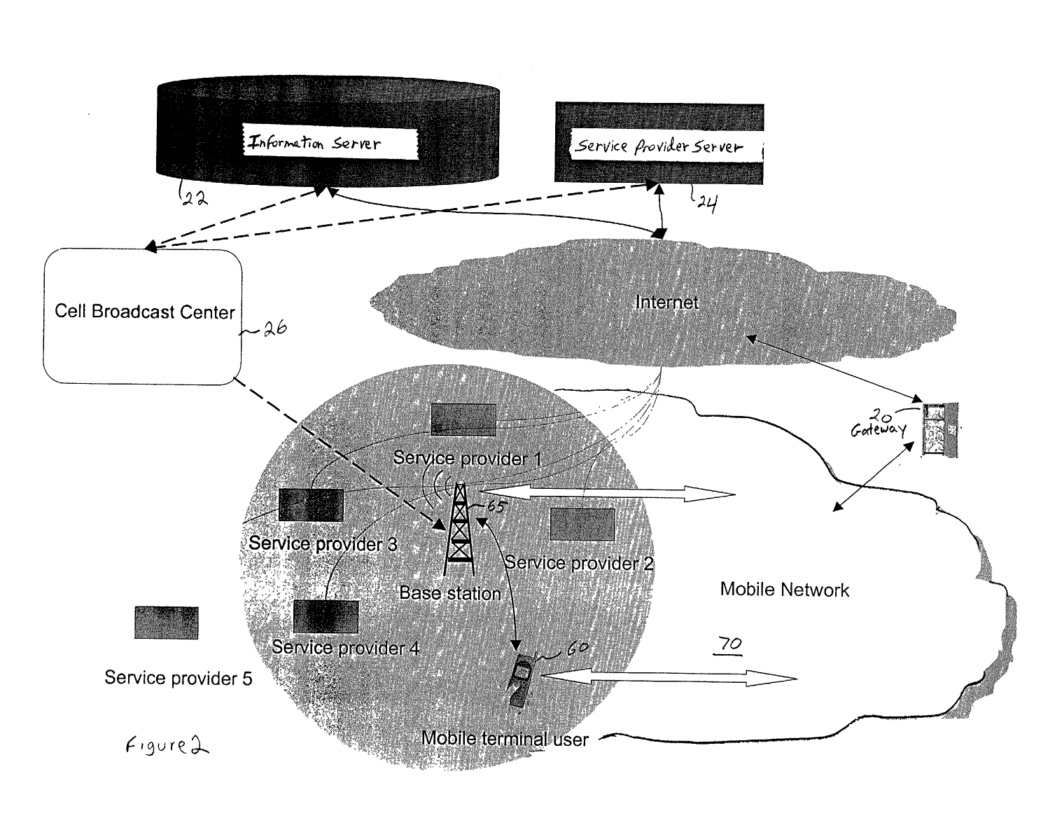

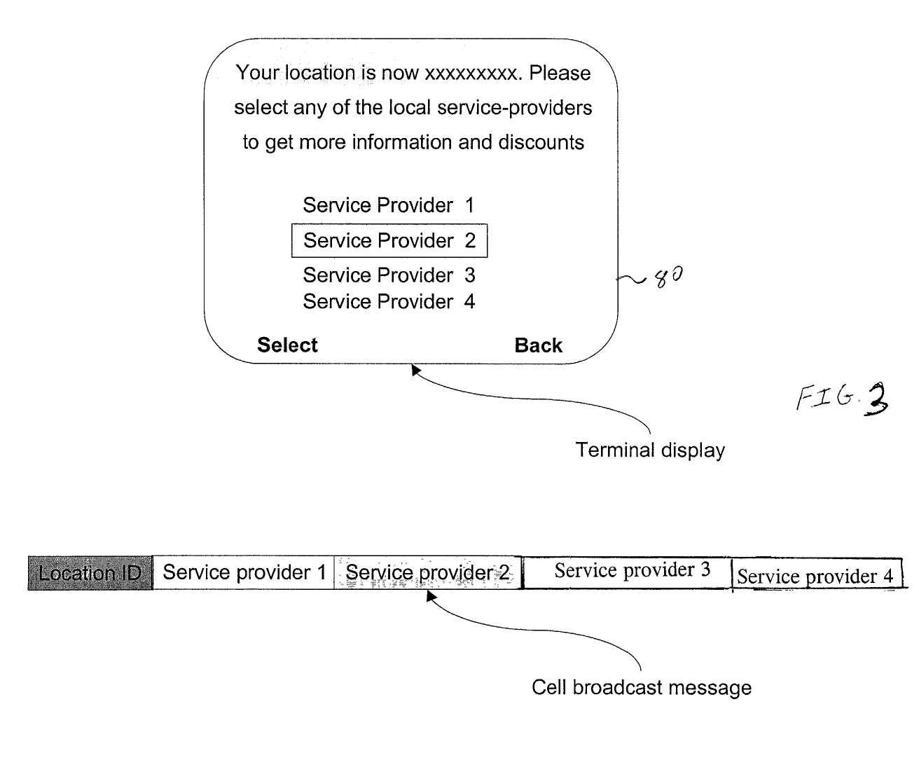

The invention is explained below with reference to FIGS. 2 and 3 wherein one embodiment of a mobile network is shown. The network 70 may be, for example, a GSM mobile communication system, as known in the art, having a plurality of base stations (BTS), one of which is shown as item 65, with each having an operating range for communicating with mobile stations (MS) located within the BTS 65 operating range. The network 70 may be connected through a gateway 20, to other networks such as the Internet, which is shown in communication with an information server 22 and a service provider server 24, as explained more fully below. The base stations are controlled by a cell broadcast center 26, typically located outside of the mobile network, and broadcast on their respective cell broadcast channels information intended to be received by all mobile stations MS in communication with the base stations, which includes, in accordance with the present invention, the BTS location information. Thus, while an MS is activated, it is in periodic or constant communication with one or more base stations 65, thereby allowing a base station to identify a general location of a particular MS 60, e.g., that the MS 60 is within communication range and, therefore, within the geographic coverage area of BTS 65. The BTS 65 broadcasts plain language location information (e.g., x, y coordinates) obtained from a cell broadcast center.

As also shown in FIG. 2, the geographic coverage area of the BTS 65 contains numerous and varying types of service providers, such as restaurants, automotive service stations, cinemas, etc. Five service providers are shown, four of which are located in the BTS 65 coverage area. The service providers are in communication with the information server 22 and service provider server 24 either through communication with the mobile network 70 or through a separate communication system (e.g. the internet, etc.). The information server 22 contains information about specific service providers. The service providers may also be in communication with a designated service provider server 24 containing general information pertaining to the service providers. The servers 22, 24 are also in communication with the cell broadcast center 26, e.g., via the mobile network 70 or the Internet, and provide the cell broadcast center with information concerning the service providers so that the information can be forwarded to an MS via the BTS 65, as explained below. For example, service provider 2 is shown in FIG. 2 as being in communication with the Internet and with information server 22 and the service provider server 24. Service provider 2 may be, as an example, a franchise business, such as a restaurant. In this case, the service provider server 24 may provide general information about promotions offered by all franchise locations, while information server 22 provides specific information such as a location-specific promotion pertaining to a specific franchise location (e.g., service provider 2). This information is forwarded to the cell broadcast center 26 for broadcast to the mobile stations located within the range of the BTS 26.

The location information broadcast from the base stations BTS is controlled by the cell broadcast center 26 that commands the base stations to broadcast location information. The cell broadcast center maintains the location information used by the base stations for broadcasting. The location information in the invention is specific for each cell, in which case each base station BTS embodying the inventive functionality broadcasts its location information over an assigned base station broadcast channel. The location information can be different for each base station, in which case each base station is instructed to broadcast its own specific location information.

In one embodiment, service provider information is automatically communicated between the BTS and MS when an MS enters the geographic region of the BTS 65. The BTS will forward the service provider identity information to the MS along with the BTS location information—both of which are sent through the base station broadcast channel. Thus, an exemplary cell broadcast message will include the MS location identification as well as the identifications of the available service providers, as shown in FIG. 3.

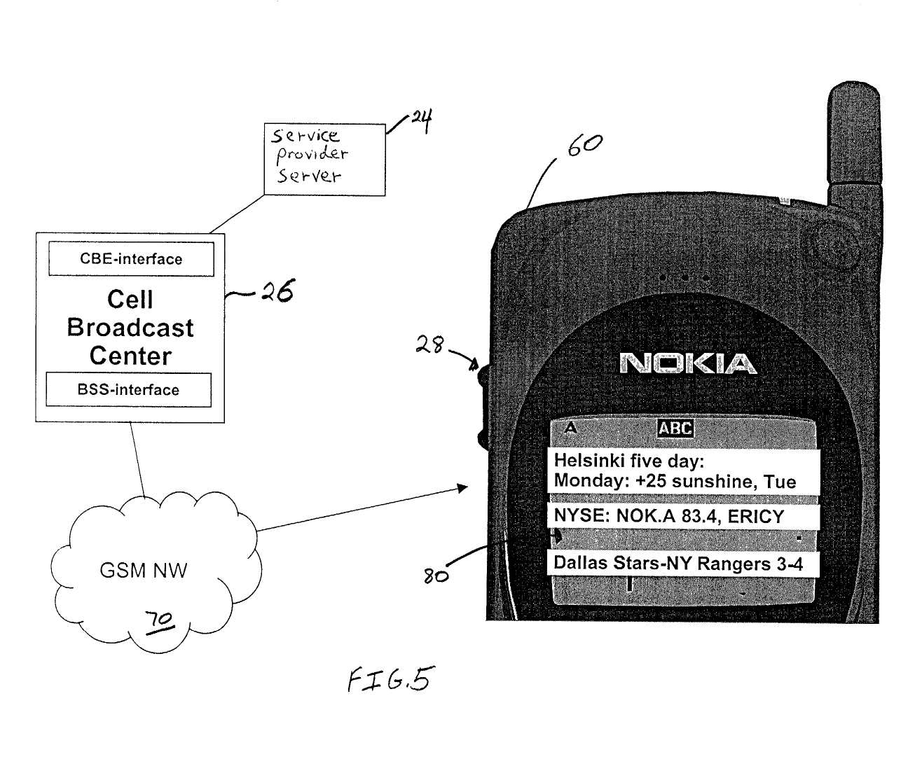

The service provider identities will be conveyed to the MS for use by the user. Such conveyance can be in the form of a visual menu on a display 80 of the MS 60, an example of which is shown in FIGS. 3 and 5, or, in another embodiment, via an audio message. In the case of a visual menu, and with reference again to the base station 65 shown in FIG. 2, four service providers are shown located within the geographic region of the BTS 65 while service provider 5 is not. Thus, the terminal display screen 80 will list the four providers but not service provider 5 (FIG. 3). It should be appreciated that although the display 80 depicts the available service providers in a list format and includes the location information which is visible by the user, this is only an example and other display layouts or formats can be used, with or without display of the location information to the user, without departing from the scope of the invention.

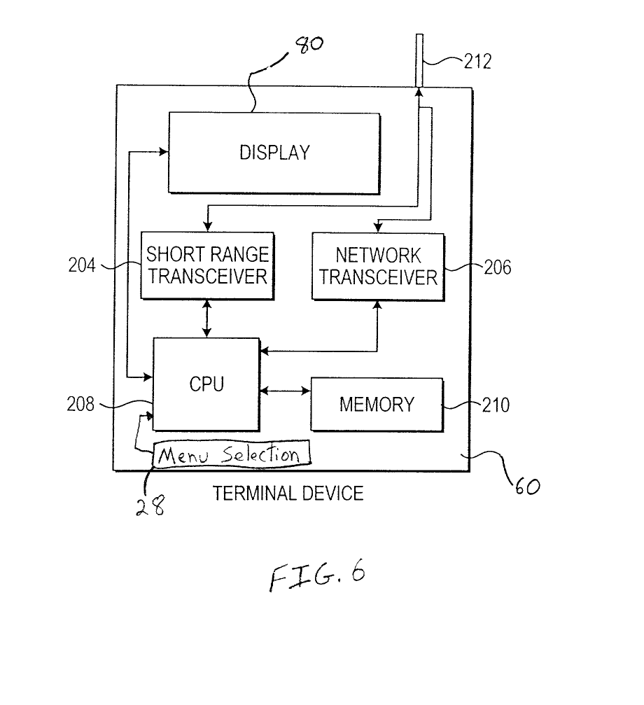

From the display menu, a user can then simply select, by using appropriate buttons (e.g., menu selection buttons 28 shown in FIGS. 5 and 6) or a touch sensitive screen, or various other selection means known in the art, an entry of a desired service provider. Upon selection, an information request along with the previously transmitted location information will be sent to the information server 22 via the mobile network 70 and/or the Internet. As the location information provided by the BTS to the MS and, then, provided from the MS to the information server or service provider server is in plain language, a separate key code or conversion table is not needed to decipher the location information. In response to the request, the information server 22 or service provider server 24 will transmit services information to the MS via the mobile network 70.

A detail of the terminal device, e.g., mobile phone 60 is illustrated in FIG. 6. As shown, the mobile phone includes the display 80, such as an LCD display as is known in the art, a central processing unit (CPU) 208 a memory 210 and a menu selection means 28, such as selection buttons, touch sensitive screen, etc., for selecting an item displayed on the display 80. Standard mobile transmission and reception occurs via a network transceiver 206 connected to an antenna 212, and short messaging is conducted via a short range transceiver 204 connected to the antenna.

In one embodiment, a WAP link corresponding to a service provider may be broadcast in the cell broadcast channel 26 by the cell broadcast center 26. An MS having WAP capability can then select the service provider from a menu and the WAP link will be used to contact the selected service provider to obtain additional provider information.

In another embodiment, the services information will be location specific, i.e. it will pertain to a particular service provider location such as a special offer available at the service provider location.

In yet another embodiment, the service information request may be transmitted without the MS location information, in which event the MS will be provided with non-location specific or general information about the selected service provider (e.g., general promotions available at all service provider locations, etc.).

The services information request sent by the MS 60 may be in the form of a short message or via transmission through the BTS 65 via the mobile network 70 as is known in the art. Likewise, the information responsive to the request may be by SMS or through the mobile network 70.

In one embodiment the invention can be implemented in the context of a low power or screen saver mode wherein power to the display 80 of an MS is reduced or placed in “standby” when, for example, inactivity on an MS keypad or no incoming call occurs for a duration of time. Such screen saver implementation for mobile stations are disclosed in published PCT application WO 99/59283 (De Boor) and European Patent EP 1 056 261 A2 (Aho). Use of the invention in the context of a screen saver mode is illustrated in FIG. 5 wherein one or more service providers 24 are connected to or otherwise in communication with the cell broadcast center 26 which interfaces the service provider information with the network 70. The cell broadcast center may contain categories of information provided by the service providers, such as, traffic, weather, financial and sports information. The information categories will be communicated to the MS 60 in any known manner, whereupon a user can select, using keys 28, for example, particular categories of interest. The categories may be stored in a user's preference file maintained at or for the mobile network provider. Then, when the MS enters a standby mode and this occurrence is detected, such as by the base station 65 signaling the cell broadcast center 26 the cell broadcast center—knowing the general location of the MS 60 via the location information from the BTS 65—will convey information from the selected categories for display on the MS display 80. When the MS 60 exits the standby mode such as when a designated key 28 is depressed, display of the information will cease.

In other words, once the MS enters a standby mode, it will automatically receive provider information from the cell broadcast center 26 through the cell broadcast channel via communication with base station 65. This information may be general—including all service provider information broadcast by the base station to all mobile station in the broadcast region, or may be selected on a filtered based on pre-specified user preferences. In this embodiment, it is contemplated that a standby mode bypass key or switch or filter be included on the MS to prevent the MS from exiting the standby mode unless such action is desired by the user. This will allow the user to access the MS function keys to select among the received provider information without terminating such transmission, i.e. without exiting the standby mode.

As shown in FIG. 5, a user of the MS 60 selected “weather”, “financial”, and “sports” information which are, in one embodiment, displayed in the form of banner or scroll type ads on the display 80.

As the mobile station MS 60 moves within the mobile network, it will be in communication with a different base station than BTS 65. As will be appreciated, such a different base station will have its own operating region encompassing one or more different service providers, whereupon service provider information pertaining to such other service providers will be available, in a manner explained above, via the information server 22 or the service provider server 24.

It should be noted that the present invention does not require the user to input any textual information via the MS 60. Rather, the user need only select the desired service provider name from the transmitted menu of available service providers or, select the categories of information. The transmitted responsive information will be the last updated information pertaining to the selected service provider, which is stored in the information server 22 or service provider server 24.

For information updating, local service providers may periodically communicate with the information server 22 to provide information regarding new offers, discounts, promotions, etc.

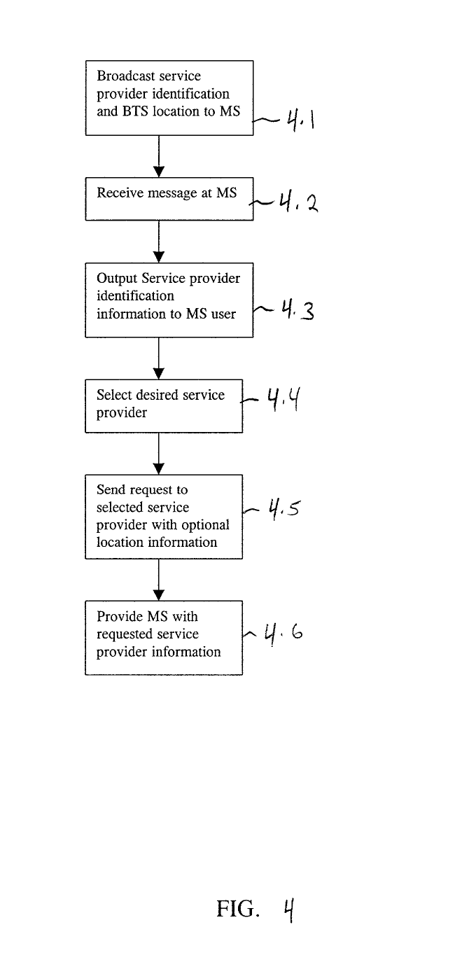

A method in accordance with the present invention is depicted in the flow diagram of FIG. 4. The method requires location information and service provider information to be transmitted from a base transceiver station to a mobile station on a call broadcast channel (step 4.1). The transmitted information is received by the MS (step 4.2) and output (either by audio or visual display) (step 4.3). The MS user will then select the desired service provider from the menu (step 4.4) and the MS will send a request to the selected service provider (with or without location information) (step 4.5). The requested information will then be provided to the MS (step 4.6).

Thus, while there have shown and described and pointed out fundamental novel features of the invention, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for providing service information to a mobile station in communication with a base transceiver station, the method comprising the steps of:
a) broadcasting over the cell broadcast channel of the base transceiver station a message including location information identifying a geographic location of the base transceiver station and information identifying service providers located within a coverage area of the base transceiver station;
b) receiving at the mobile station the broadcast message;
c) storing at least the location information identifying the geographic location of the base transceiver station into a memory of the mobile station and conveying to the mobile station for access by a user of the mobile station at least the identifying service provider information;
d) selecting at least one service provider from the identifying service provider information;
e) associating the selected service provider with the location information stored in the memory of the mobile station;
f) sending a request for service information of the selected service provider to a dedicated server, the request optionally containing service provider location association depending on a user preference; and
g) providing requested service information depending on the user preference to the mobile station.

2. The method of claim 1, wherein the step of broadcasting comprises broadcasting plain language location information identifying the geographic location of the base station.

3. The method of claim 1, wherein the step of sending a request for service information comprises sending a short message.

4. The method of claim 1, wherein the location information is conveyed to a display on the mobile station.

5. The method of claim 1, wherein the information identifying service providers is displayed on a display of the mobile station.

6. The method of claim 1, wherein the information identifying service providers is conveyed to the user of the mobile station through an audio signal.

7. The method of claim 1, wherein the mobile station comprises a mobile phone.

8. A system for providing service information to a mobile station in communication with a base transceiver station, the system comprising:
a communication network including a plurality of base transceiver stations, each broadcasting periodically over a respective the cell broadcast channel a message including location information identifying a geographic location of the base transceiver station and information identifying service providers located within a coverage area of the base transceiver station;
a mobile station communicating with the communication network, said mobile station comprising:
a receiver for receiving the broadcast message;
a memory for storing at least the location information identifying the geographic location of the base transceiver station currently in communication with the mobile station;
a user interface device for outputting at least the identifying information of service providers located within the coverage area of the base transceiver station;
a selector module for selecting at least one of the service providers conveyed to the user in response to user manipulation;
means for associating the at least one selected service provider with the location information stored in the memory means; and
a transmitter for sending a request for service information of the at least one selected service provider, the request optionally containing service provider location association depending on a user preference; and
a dedicated server connected to the communication network for providing to the mobile station the requested service information depending on the user preference.

9. The system of claim 8, wherein the location information is plain language location information identifying the geographic location of the base station.

10. The system of claim 8, wherein said transmitter is capable of sending a short message.

11. The system of claim 10, wherein said dedicated server responds to said short message.

12. The system of claim 8, wherein said user interface comprises a display on said mobile station.

13. The system of claim 8, wherein the mobile station comprises a mobile phone.

14. The system of claim 8, wherein the mobile station possesses WAP capabilities and wherein the information identifying service providers comprises a WAP address link.

15. The system of claim 14, wherein the selection module is used to select the WAP address link to obtain additional information about a corresponding service provider.

16. The system of claim 8, wherein said mobile station further comprises a detector module connected to said transmitter for detecting when the mobile station enters a standby mode.

17. A mobile station in communication with a base transceiver station, comprising:
a transceiver for receiving a message broadcast over the cell broadcast channel of the base transceiver station including location information identifying a geographical location of the base transceiver station;
a storage device;
an output;
a processor, and
software means operative on the processor for maintaining in the storage device a database identifying the geographical location of the base transceiver station currently in communication with the mobile station, conveying to the user of the mobile station at least identification information of service providers locating within a coverage area of the base transceiver station at the output, selecting at least one of the service providers locating within the coverage area of the base transceiver station in response to user manipulation, associating the selected service provider with the location information maintained in the storage device, sending a request for service information of the selected service provider, the request optionally containing service provider location association depending on a user preference, and receiving a response to said request and outputting said response at the output, said response comprising service information of the selected service provider.

18. The mobile station in accordance with claim 17, wherein said software means determines whether said mobile station is in a standby mode prior to receiving a response to the request.

19. A method for providing service information to a mobile station when the mobile station enters a standby mode, said mobile station being in communication with a base transceiver station, the method comprising the steps of:
a) broadcasting over the cell broadcast channel of the base transceiver station a message including location information identifying a geographic location of the base transceiver station and information identifying service providers located within a coverage area of the base transceiver station;
b) receiving at the mobile station the broadcast message;
c) storing at least the location information identifying the geographic location of the base transceiver station into a memory of the mobile station and conveying to the mobile station for access by a user of the mobile station at least the identifying service provider information;
d) selecting at least one service provider from the identifying service provider information;
e) associating the selected service provider with the location information stored in the memory of the mobile station;
f) detecting when the mobile station enters a standby mode;
g) sending a request for service information of the selected service provider to a dedicated server when the a standby mode of the mobile station is detected, the request optionally containing service provider location association depending on a user preference; and
h) providing requested service information depending on the user preference to the mobile station.
